(19) United States
(12) Patent Application Publication
(10) Pub. No.: US 2009/0145761 A1
(43) Pub. Date: Jun. 11, 2009

(54) OXYGEN SEPARATION ELEMENT AND METHOD

(76) Inventor: Bart A. van Hassel, Getzville, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/954,060

(22) Filed: Dec. 11, 2007

(51) Int. Cl. B01D 57/02

(52) U.S. Cl. 204/550; 204/600

(57) ABSTRACT

An electrically driven oxygen separation element and method in which an oxygen containing feed stream is passed through a passageway of a composite structure having a current collector defining the passageway, a cathode electrode to ionize the oxygen, an electrolyte to transport oxygen ions to an anode to recombine into elemental oxygen. An elongated element, preferably formed of an irregular mesh of wire having loops in contact with the current collector can be provided to disrupt the flow directly adjacent the current collector and to help distribute the electrical current along the length of the current collector.

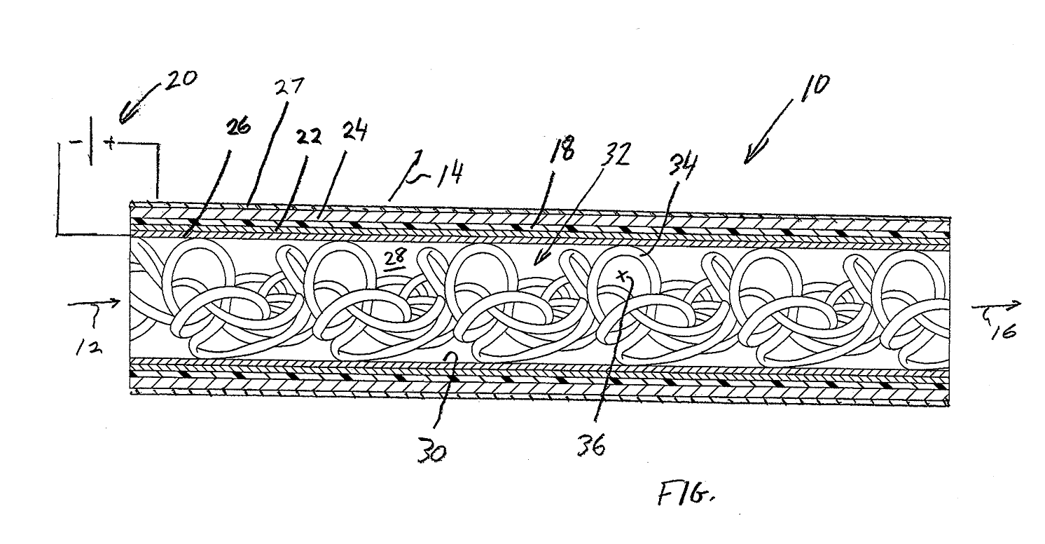

### FIELD OF THE INVENTION

The present invention relates to an oxygen separation element and method in which the oxygen separation element is electrically driven and provided with a passageway through which an oxygen containing feed stream flows for separation of the oxygen and an elongated device in contact with a current collector forming the passageway for disrupting flow and for distributing the electrical current along the current collector.

### BACKGROUND OF THE INVENTION

Electrically driven oxygen separation elements are used for separating oxygen from an oxygen containing feed. They are typically in tubular form, although other forms are possible such as flat plates having passageways between the plates. In an electrically driven oxygen separation element, an electrolyte is positioned between cathode and anode electrodes and an electrical current is applied to the electrodes. When an oxygen containing feed stream is passed along the cathode electrode, the oxygen ionizes and is driven through the electrolyte to the anode under impetus of the applied electrical current. The oxygen recombines at the anode and can either be collected or dissipated, depending upon the purpose of the electrically driven oxygen separation element. In this regard, when such an element is used as a deoxo unit to purify the feed stream, the oxygen is simply vented.

As mentioned previously, such a device can be in a tubular form or other forms having passageways for the flow of the oxygen containing feed stream. Such devices typically have a current collector positioned on the cathode electrode and such current collector thus defines the outer boundaries of the passage. A current collector is also positioned on the anode. The current collector helps to distribute the electrical current along the cathode and the anode.

A problem with such devices particularly when in tubular form, is that the flow of the oxygen containing feed stream is typically at a sufficiently low rate that a boundary layer forms along the walls of the passageway formed by the current collector. It is to be noted that the low flow rate is necessary to enable the oxygen to ionize and be completely removed (<10 ppm) from the feed stream and to prevent severe pressure drops that would require energy to be expended in compressing the feed stream. As can be appreciated, in any such device as the oxygen containing feed flows through the passageway it becomes evermore dilute and as such, oxygen molecules present in more central locations of the passageway or at least those locations more remote from the current collector are never ionized and transported through the element to the anode electrode. This phenomena is particularly pronounced with respect to purification applications of such elements in which the oxygen containing feed stream has a low concentration of oxygen to begin with.

In order to separate the oxygen from the oxygen containing feed, particularly in the case of deoxo application, electrically driven oxygen separation elements can become sufficiently long such that it becomes difficult to simply apply an electrical current at one location of the current collector. This issue has been addressed in U.S. Pat. No. 6,475,657. In this patent, an electrically driven oxygen separation element is illustrated that is in the form of a tube in which the central electrolyte is positioned between an outer cathode electrode and an inner anode electrode. Both anode and cathode electrodes are coated with current collectors. In operation, air is contacted with the outer surface of the tube and oxygen ions are transported to the inner passageway at the anode electrode. It is mentioned that an elongated current collector in the form of a wire could be placed within the tube and in addition the tube could be filled with beads of zirconia so as to improve the fastening of the wire to the current collector. The beads might also be metallic or covered with a conductor. In such case, the beads would help distribute the electrical current along the inner surface of the tube. It is to be noted that it would be disadvantageous in such an arrangement to reverse the cathode in the anode electrodes in that the presence of such beads would produce a large pressure drop within the tube resulting in a larger power consumption of the device when in use.

U.S. Published Patent Appln. No. 2005/0147857 A1 discloses a similar device, namely a tubular fuel cell element. In such element, a fuel is made to flow on the inside of the tube that is combusted in the presence of permeated oxygen to produce a pressure gradient with respect to the outer surface of the tube to drive oxygen through the tube to support the combustion. An electrical connection is made between the anode and cathode to supply electrical power to a load. In this patent, long tubes or an elongated wire brush arrangement can be provided within the tube to serve as the current collector and collect current along the length of the inner surface of the tube from the inner anode electrode thereof.

A similar problem related to boundary layer effects near the inside of oxygen separation elements exists with respect to membrane filters. Membrane filters utilize cylindrical elements in which a liquid, rather than a gas, is pumped through the tube. The tubes are made of porous ceramics that by virtue of the size of the pores allow certain constituents in the liquid to pass through the pores outwardly of the tube. In such devices, a concentration polarization can exist in a transverse direction of the tube. In order to combat this, fluid velocity is increased until the flow becomes turbulent. Alternatively, elongated structures have been placed inside the tubes as inserts to produce turbulent fluid flow within the tubes. An example of this can be found in Costigan, Journal of Membrane Science, Vol. 206, pp. 179-188 (2002). In this article, it is mentioned that corkscrew-like inserts can be provided for such purposes. Cylindrical rods and helical baffles are disclosed for such purposes in Chiu, Separation and Purification Technology, Vol. 51, pp. 233-239 (2006). The problem of utilizing such inserts with respect to electrically driven oxygen separation devices is that when placed in the passageway, they would result in a substantial pressure drop.

As will be discussed, the present invention provides an electrically driven oxygen separation element and method in which an insert is placed within a passageway thereof to not only disrupt flow of the oxygen containing feed stream in contact with the inner current collector associated with a cathode, but also, to distribute the current along the length of the tube.

### SUMMARY OF THE INVENTION

In one aspect, the present invention provides an electrically driven oxygen separation element to separate oxygen from an oxygen containing feed stream. The oxygen separation element is provided with a composite structure having an electrolyte capable of oxygen ion transport upon application of an electrical current thereto. Cathode and anode electrodes are located on opposite sides of the electrolyte for applying the electrical current to the electrolyte. Current collectors are in contact with the cathode and anode electrodes for applying the electrical current to the cathode and anode electrodes.

The composite structure is configured such that a passageway formed having an inner surface defined by one of the current collectors in contact with the cathode electrode to allow the oxygen containing feed stream to pass through the passageway and the oxygen to be separated therefrom through the electrolyte, from the cathode electrode to the anode electrode, when an electrical current is applied thereto.

An elongated insert is located within the passage. Such insert has an open structure formed of elements configured to generate turbulence in the flow of the oxygen at least adjacent to the inner surface such that the oxygen contained in the oxygen containing feed stream remote from the inner surface and flowing within the passageway is able to contact the inner surface and be separated from the oxygen containing feed stream. The elongated insert is in contact with the inner surface and is fabricated from an electrically conductive material to promote distribution of the electrical current along the one of the current collectors.

Preferably the composite structure is of tubular configuration. The elongated insert can be formed by an irregular, mesh of wire having loops of wire to form the open structure. The loops of wire are in contact with the inner surface.

In another aspect, the present invention provides a method of contacting an oxygen containing feed stream with an electrically driven oxygen separation element to separate oxygen from the oxygen containing feed stream. In accordance with this method of the present invention the oxygen containing feed stream is introduced into a passageway of a composite structure forming the electrically driven oxygen separation element. The composite structure comprises an electrolyte capable of oxygen ion transport upon application of an electrical current thereto. Cathode and anode electrodes located on opposite sides of the electrolyte are provided for applying the electrical current to the electrolyte. Current collectors are in contact with the cathode electrode and the anode electrode for applying the electrical current to the cathode electrode and the anode electrode. The composite structure is configured such that the passageway is formed having an inner surface defined by one of the current collectors in contact with the cathode electrode.

Turbulence in the flow of the oxygen containing feed stream is generated at least adjacent to the inner surface with an elongated, electrically conductive insert located within the passageway and having an open structure. The result is that the oxygen contained in the oxygen containing feed stream remote from the inner surface and flowing through the passageway is able to contact the inner surface and be separated from the oxygen containing feed stream. Distribution of the electrical current is promoted along the one of the current collectors in contact with the cathode electrode through contact of the elongated electrically conductive insert with the inner surface along the length of the passageway.

Preferably, the composite structure is of tubular configuration and the elongated, electrically conductive insert is an irregular, mesh of wire having loops of wire in contact with the inner surface. The oxygen containing feed stream in any aspect of the present invention can contain no more than five percent by volume of oxygen. As such, the electrically driven oxygen separation element can advantageously function within a device that is used to purify a feed stream that contains low amounts of oxygen.

### BRIEF DESCRIPTION OF THE DRAWING

While the specification concludes with claims distinctly pointing out the subject matter that Applicants regard as their invention, it is believed that the invention will be better understood when taken in connection with the accompanying drawings in which the sole FIGURE illustrates an apparatus for carrying out a method in accordance with the present invention.

### DETAILED DESCRIPTION

With reference to the FIGURE, an electrically driven oxygen separation element 10 is illustrated that is designed to be utilized within a device to separate oxygen from an oxygen containing feed stream 12 to produce an oxygen permeate 14. The separation of oxygen produces an oxygen depleted retentate 16. As known in the art, oxygen separation element 10 could be utilized within a device that has an insulated enclosure having heating elements to heat electrically driven oxygen separation element 10 to an operational temperature. A blower can be utilized to introduce oxygen containing feed stream 12 into oxygen separation element 10, all in a manner well known in the art.

Oxygen separation element 10 is of tubular configuration and is provided with an electrolyte 18 that can be yttrium stabilize zirconia, gadolinium doped ceria or other ionic conductors that when heated will exhibit oxygen ion conductivity when an electrical current produced by power source 20 is applied to cathode and anode electrodes 22 and 24 that are respectively located on opposite sides of electrolyte 18. The electrical current is applied to a cathode electrode 22 by way of a current collector 26 that distributes the electrical current to the cathode electrode 22. The electrical current is applied to an anode electrode 24 by way of a current collector 27 that distributes the electrical current to the anode electrode 24.

Electrically driven oxygen separation element 10 is of tubular form and as such the current collector 26 defines an inner surface 28 of a passageway 30 through which the oxygen containing feed stream 12 flows. Although oxygen separation element 10 is of tubular form known other forms having more than one passageway such as passageway 30 can be used such as flat plate and honeycomb-type construction.

Particularly in the case when oxygen containing feed stream 12 is to be purified and thus contains low concentration of oxygen, for example no more than five percent by volume, as the oxygen containing feed stream 12 flows through passageway 30 a boundary layer can build up on the inner surface 28 of passageway 30 in which oxygen from locations that are remote from the inner surface 28 of passageway 30 are not to contact the current collector 26 and enter a cathode electrode 22 to be ionized. As mentioned above, in order to obtain the desired concentration of oxygen in retentate stream 16, the length of oxygen separation element 10 must be increased.

It is to be noted that each of the current collector layers 26 and 27 are porous and yet electrically conductive. Thus, each of the current collector layers 25 and 26 can be formed of a silver or silver alloy or more durable mixtures of an electrically conductive metal or metal alloy such as silver and metallic oxide such as yttrium stabilize zirconia. Current collectors have been advantageously formed by a partially sintered masses of silver particles coated with yttrium stabilized zirconia to provide enhanced durability and aging characteristics. Cathode electrode 22 can be a mixture of silver and the ionic conductor or can be a mixture of an electrically conductive perovskite and the material used in forming the electrolyte 18. Cathode electrode 22 is also porous for transport of the oxygen ions to the electrolyte 18. Anode electrode 24 as known in the art is also porous and can be constructed of the same material as the cathode electrode 22 and have a sufficient thickness to provide structural integrity of the electrically driven oxygen separation element 10. It is to be noted, however, that the present invention is applicable to any electrically driven oxygen separation element and no particular material formulation for the anode, cathode or electrolyte is preferred.

In order to avoid a boundary layer formation close to the inner surface 28 of the passageway 30 that would inhibit oxygen from ionizing from remote locations of passageway 30, for example, more central locations, an elongated insert 32 is provided within passageway 30. As illustrated, elongated insert 32 has an open structure that permits the oxygen containing feed stream 12 to flow in an axial direction of the passageway. This axial direction would be given by the direction of the arrowheads designated by reference numerals 12 and 16. As illustrated, elongated insert 32 is an irregular mesh of wire having loops for example, loop 34 in contact with the current collector layer 26. In this regard, the elongated insert 32 by provision of such loops allows for the flow of the oxygen containing feed stream 12 to pass in the axial direction although, turbulence is generated in the flow both close to the inner surface 28 of the passageway 30 and also in more remote locations, for example, remote location “X” designated by reference number 36. In addition, the elongated insert 32 is constructed of electrically conductive material, for example, silver, stainless or inconel and a great number of the loops will contact the current collector 26 to help distribute the electrical current along the length of the current collector 26. The particular elongated insert 32 was obtained from Cal Gabin Limited of Warwickshire, United Kingdom. As can be appreciated, other similar devices could be used in accordance with the present invention. For example, a coil of wire could be placed within passageway 30 so that turbulence in the flow of the oxygen containing feed stream 12 near the inner surface 28 of the passageway 30 but not at more remote locations situated at a distance from the inner surface 28 of passageway 30.

While the present invention has been described with reference to a preferred embodiment, as will occur to those skilled in the art, numerous changes and additions and omissions can be made without departing from the spirit and the scope of the present invention as set forth in the presently pending claims.

We claim:

1. An electrically driven oxygen separation element to separate oxygen from an oxygen containing feed stream comprising:
a composite structure comprising an electrolyte capable of oxygen ion transport upon application of an electrical current thereto, cathode and anode electrodes located on opposite sides of the electrolyte for applying the electrical current to the electrolyte and current collectors in contact with the cathode electrode and the anode electrode for applying the electrical current to the cathode electrode and the anode electrode;
the composite structure configured such that a passageway is formed having an inner surface defined by one of the current collectors in contact with the anode electrode to allow the oxygen containing feed stream to pass through the passageway and the oxygen to be separated therefrom through oxygen ion transport through the electrolyte, from the cathode electrode to the anode electrode, when the electrical current is applied thereto; and
an elongated insert located within the passageway and having an open structure formed of elements configured to generate turbulence in the flow of the oxygen containing feed stream at least directly adjacent the inner surface such that the oxygen contained in the oxygen containing feed stream remote from the inner surface and flowing within the passageway is able to contact the inner surface and be separated from the oxygen containing feed stream;
the elongated insert in contact with the inner surface along the passageway and fabricated from an electrically conductive material to promote distribution of the electrical current along the one of the current collectors in contact with the cathode electrode.

2. The electrically driven oxygen separation element 1 wherein the composite structure is of tubular configuration.

3. The electrically driven oxygen separation element of claim 2, wherein the elongated insert is an irregular, mesh of wire having loops of the wire forming the open structure, the loops of wire in contact with the inner surface.

4. A method of contacting an oxygen containing feed stream with electrically driven oxygen separation element to separate oxygen from an oxygen containing feed stream comprising:
introducing the oxygen containing feed into a passageway of a composite structure forming the electrically driven oxygen separation element;
the composite structure comprising an electrolyte capable of oxygen ion transport upon application of an electrical current thereto, cathode and anode electrodes located on opposite sides of the electrolyte for applying the electrical current to the electrolyte and current collectors in contact with the cathode electrode and the anode electrode for applying the electrical current to the cathode electrode and the anode electrode;
the composite structure configured such that the passageway is formed having an inner surface defined by one of the current collectors in contact with the cathode electrode; and
generating turbulence in the flow of the oxygen containing feed stream at least directly adjacent the inner surface with an elongated, electrically conductive insert located within the passageway such that the oxygen contained in the oxygen containing feed stream remote from the inner surface and flowing through the passageway is able to contact the inner surface and can be separated from the oxygen containing feed stream; and
promoting distribution of the electrical current along the one of the current collectors in contact with the cathode electrode through contact of the elongated, electrically conductive insert with the inner surface along the length of the passageway.

5. The method of claim 7, wherein the composite structure is of tubular configuration and the elongated, electrically conductive insert is an irregular, mesh of wire having loops of the wire in contact with the inner surface.

6. The method of claim 4, wherein the oxygen containing feed stream contains no more than about five percent by volume of oxygen.
